(19) United States
(12) Patent Application Publication
(10) Pub. No.: US 2025/0139637 A1
(43) Pub. Date: May 1, 2025

(54) NON-INVASIVE COLLABORATIVE BROWSING

(71) Applicant: Loop Now Technologies, Inc., San Mateo, CA (US)

(72) Inventors: Jing Xian Chen, Dublin, CA (US); Nga Lun Helen Lam, Montreal (CA); Jerry Ting Kwan Luk, Menlo Park, CA (US); Ziming Zhuang, Palo Alto, CA (US)

(73) Assignee: Loop Now Technologies, Inc., San Mateo, CA (US)

(21) Appl. No.: 18/926,446

(22) Filed: Oct. 25, 2024

Related U.S. Application Data
(60) Provisional application No. 63/649,966, filed on May 21, 2024.
(60) Provisional application No. 63/638,476, filed on Apr. 25, 2024.
(60) Provisional application No. 63/571,732, filed on Mar. 29, 2024.
(60) Provisional application No. 63/557,622, filed on Feb. 26, 2024.
(60) Provisional application No. 63/557,623, filed on Feb. 26, 2024.
(60) Provisional application No. 63/557,628, filed on Feb. 26, 2024.
(60) Provisional application No. 63/613,312, filed on Dec. 21, 2023.
(60) Provisional application No. 63/604,261, filed on Nov. 30, 2023.
(60) Provisional application No. 63/546,768, filed on Nov. 1, 2023.
(60) Provisional application No. 63/546,077, filed on Oct. 27, 2023.

(51) Int. Cl. G06Q 30/015; G06F 16/955

(52) U.S. Cl. CPC G06Q 30/015; G06F 16/955

(57) ABSTRACT

A computer-implemented method for video sharing is disclosed. A website which hosts multiple users and includes numerous products for sale is accessed. User information is collected and used to match a user with a sales associate. A communications agent is installed on the website which enables an interaction between a website user and a sales associate. The sales associate can be a human or an artificial intelligence agent. The user information is used to predict purchasing intentions of the user. The sales associate can obtain a uniform resource locator (URL) within the website domain based on the purchasing intentions of the user and can direct the user's web browser to the URL, with the user's approval. The directing to the URL is accomplished without taking control of the user's device. The directing is based on the communications agent installed on the website.

### RELATED APPLICATIONS

This application claims the benefit of U.S. provisional patent applications “Non-Invasive Collaborative Browsing” Ser. No. 63/546,077, filed Oct. 27, 2023, “AI-Driven Suggestions For Interactions With A User” Ser. No. 63/546,768, filed Nov. 1, 2023, “Customized Video Playlist With Machine Learning” Ser. No. 63/604,261, filed Nov. 30, 2023, “Artificial Intelligence Virtual Assistant Using Large Language Model Processing” Ser. No. 63/613,312, filed Dec. 21, 2023, “Artificial Intelligence Virtual Assistant With LLM Streaming” Ser. No. 63/557,622, filed Feb. 26, 2024, “Self-Improving Interactions With An Artificial Intelligence Virtual Assistant” Ser. No. 63/557,623, filed Feb. 26, 2024, “Streaming A Segmented Artificial Intelligence Virtual Assistant With Probabilistic Buffering” Ser. No. 63/557,628, filed Feb. 26, 2024, “Artificial Intelligence Virtual Assistant Using Staged Large Language Models” Ser. No. 63/571,732, filed Mar. 29, 2024, “Artificial Intelligence Virtual Assistant In A Physical Store” Ser. No. 63/638,476, filed Apr. 25, 2024, and “Ecommerce Product Management Using Instant Messaging” Ser. No. 63/649,966, filed May 21, 2024.

Each of the foregoing applications is hereby incorporated by reference in its entirety.

### FIELD OF ART

This application relates generally to video sharing and more particularly to non-invasive collaborative browsing.

### BACKGROUND

The world of ecommerce has revolutionized the way in which we buy and sell goods and services. Access to the Internet allows businesses to connect with customers more quickly and provide their products more directly. Online retailing allows vendors to sell their wares directly to consumers. Nearly every consumer product and service can be bought and sold in online marketplaces. Both new and used goods can be purchased and sold, auctioned, or bartered though internet exchanges. Business-to-business platforms are available as well. Companies can acquire raw materials, components, or finished goods from other businesses through digital channels. Online auctions allow private individuals and businesses to sell and bid on items, from auto parts to pocket watches, wall art to diapers, though real-time auctions.

Ecommerce transactions are accomplished electronically. Customers can find products on various websites, add them to virtual shopping carts, check out, and make payments without physical interactions with another person. Secure payment processes allow customers to pay for items using their bank accounts, credit cards, lines of credit, brokerage accounts, and so on. Ecommerce purchases can be made using a smartphone. Technologies allow a user to purchase, track, and confirm delivery of items from a single handheld device. Electronic Funds Transfer (EFT) allows seamless money transfers between buyers and sellers. Private sales can be handled using financial applications that can move money from account to account quickly and securely. Marketing efforts have become highly sophisticated, allowing sellers to target specific groups of consumers who are most likely to purchase their products. Information collected about consumers as a group or as individuals can be highly prized and used as a valuable commodity between businesses and conglomerates. Ecommerce business models include business-to-consumer (B2C), in which retailers sell directly to individual consumers; business-to-business (B2B), where companies trade with other businesses; and consumer-to-consumer (C2C), in which individuals can sell items to one another.

There are many advantages to ecommerce: convenience-customers can shop anytime from anywhere without visiting a physical store; global reach-businesses can access a worldwide customer base without geographic boundaries; and cost efficiency-online operations can require fewer overhead costs than brick-and-mortar stores. There are still overhead costs associated with ecommerce. Webstore design and maintenance, online security, transaction processing fees, inventory control, shipping and transportation, operations and sales staff, procurement, and so on are necessary parts of running an effective and efficient e-business. Many customers prefer a blend of convenience and personal interaction as they shop. Social media platforms have become outlets for advice, trendsetting, product demonstrations, recommendations, and complaints. While professional marketers and advertising companies place targeted commercials in the electronic marketplace, social media influencers and individual consumers can have a powerful voice in promoting or criticizing a product or vendor. Videos can allow a vendor, influencer, or advertiser to highlight and sell products in real time with a worldwide audience. From the comfort of one's living room or while traveling on a bus, a consumer can watch a product be demonstrated, chat with other consumers or a host, buy products, and respond to what they like or dislike in real time and with immediate effect. The ecommerce trend is here to stay, forming a dynamic marketplace ecosystem that can shape our digital lives and transform traditional business models.

### SUMMARY

Ecommerce websites have become an integral part of buying and selling throughout the world. Businesses large and small depend upon website domains to act as their digital storefronts. Many businesses do not own brick-and-mortar locations, preferring to transact all of their operations through digital channels. Nevertheless, many customers prefer the ability to interact with sales representatives, owners, and product experts in the course of selecting and purchasing goods and services. Website domains can be monitored as users interact with webpages. User questions, comments, and requests to purchase products can be routed to sales associates who can respond to inquiries and oversee sales without taking control of the devices used by customers. A machine learning model can analyze user information and purchasing intentions and match the user to a sales representative who can interact with the user and enhance the user's experience. An AI agent can recognize responses from the user to approve the redirection of a user's browser to obtain product information or complete product purchases. The result is an interactive digital storefront that can anticipate customer needs, provide relatable customer support, increase sales, and promote repeat business.

A computer-implemented method for video sharing is disclosed. A website which hosts multiple users and includes numerous products for sale is accessed. User information is collected and used to match a user with a sales associate. A communications agent which enables an interaction between a website user and a sales associate is installed on the website. The sales associate can be a human or an artificial intelligence agent. The user information is used to predict purchasing intentions of the user. The sales associate can obtain a uniform resource locator (URL) within the website domain based on the purchasing intentions of the user, and can direct the user's web browser to the URL, with the user's approval. The directing to the URL is accomplished without taking control of the user's device. The directing is based on the communications agent installed on the website.

A computer-implemented method for video sharing is disclosed comprising: accessing a website within a website domain, wherein the website includes one or more products for sale, and wherein the website is viewed by a plurality of users with a plurality of devices; installing a communications agent on the website, wherein the communications agent enables an interaction between a user within the plurality of users and a sales associate; establishing the interaction between the sales associate and the user, wherein the interaction includes an overlay on the website; obtaining a uniform resource locator (URL), by the sales associate, wherein the URL is located within the website domain; and directing a web browser on a device of the user, to the URL, wherein the directing is accomplished without control of the device, wherein the user approves the directing, and wherein the directing is based on the communications agent. In embodiments, the user approves the directing by voice, chat, text, or video. Some embodiments comprise recognizing approval, of the user, by an artificial intelligence agent. In embodiments, the directing is initiated by the artificial intelligence agent. In embodiments, the recognizing includes evaluating, by the artificial intelligence agent, the interaction.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for non-invasive collaborative browsing.

FIG. 2 is a flow diagram for enabling non-invasive collaborative browsing.

FIG. 3 is an infographic for non-invasive collaborative browsing.

FIG. 4 is an example of collaborative browsing.

FIG. 5 is an infographic for alerting a sales associate.

FIG. 6 is an example of prioritizing users.

FIG. 7 is an example of an ecommerce purchase environment.

FIG. 8 is a system diagram for non-invasive collaborative browsing.

### DETAILED DESCRIPTION

Ecommerce websites have become the most popular method of purchasing goods and services in many parts of the world. Nearly every product and service imaginable can be found on at least one website somewhere in the world. Even with this expansive ecommerce availability, the desire for interaction with sales and customer service staff remains high. People like to buy products from other people they know, like, and trust. Forming a working connection between a sales associate and a customer greatly increases the chances for a sale both today and in the future. Great customer service gets noticed by social media influencers, product experts, and satisfied customers. Social media platforms thrive off positive and negative feedback about great or terrible purchasing experiences. When a customer walks into a store, regardless of what is being sold, many of the same stages of the purchasing process apply. At first, the customer may simply wander around, barely glancing at some items, sometimes looking at others more intently. Once in a while, a price might be checked, a sticker read, or a size verified. Articles of clothing get held up in a mirror, a car door is opened, a golf club is swung in an aisle. As browsing continues, some customers begin to show more interest. An item gets a second look, a chat with a friend or a picture is sent with a text. The level of interest has increased. Perhaps the customer begins to search for a salesperson. An attentive salesperson is already aware of the customer. As the browsing has continued, the salesperson has been watching and estimating the customer's intentions. Professional salespeople know how to distinguish real interest from casual browsing. While they can be surprised, a practiced salesperson can recognize what a person can afford, what brands or styles a customer is likely to prefer, and whether those accompanying the customer will be helpful or a hindrance to a sale. The observant salesperson knows when to ask the question, “May I be of assistance?” and how to follow it up with just the right answers, advice, and counsel to close a sale. The best salespeople form a relationship, however temporary, that makes a customer feel recognized, valued, and cared for. And they welcome the customer back when they return. When ecommerce transactions lack this type of personal interaction, sales can fall. Disclosed techniques can increase engagement of ecommerce transactions through video sharing.

Techniques for video sharing are disclosed. An ecommerce website within a website domain is accessed. The website contains multiple products for sale and can be accessed by multiple customers using various forms of internet browsing devices. A communications agent is installed on the website domain server or servers. The communications agent can establish an interaction between sales associates and users through an overlay on the ecommerce website. Communication between a sales associate and a user can be created and maintained without taking control of the user's browsing device. An artificial intelligence (AI) agent can monitor user interaction with the domain webpages and estimate the user's purchasing intentions. The AI agent can include a machine learning model. User information can be combined with purchasing intentions and can be matched to a sales associate with qualities that will engage and encourage the user. In circumstances when a human sales associate is unavailable, a digital AI agent can be generated. The AI agent can be fashioned to complement the user's background, characteristics, demographics, and other factors in order to best engage the user. The machine learning model can also analyze the webpages on the domain and select those pages which best address the user's questions and increase user interest. The sales associate, human or AI, can send the URL of appropriate webpages to the user's browser as they interact with the user. The URL can be sent to the user's browser without taking control of the user's device. The URL can include short-form videos, livestreams, and other product information to help the user gain the information they need. The URL can also include an ecommerce environment, so that the user can complete purchases of products as the livestream or other videos play. The AI sales agent can recognize verbal responses, signals, and gestures that indicate a decision to purchase products, just as a human sales associate can. The result is an interactive experience for the customer that increases the chance of a sale today and of future sales tomorrow.

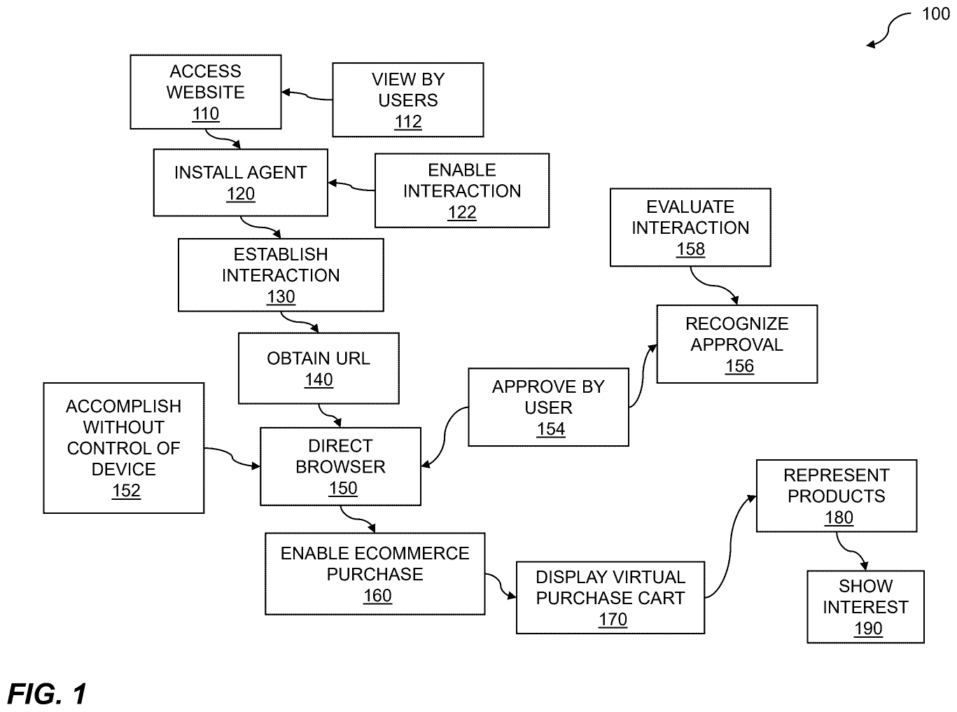

FIG. 1 is a flow diagram for non-invasive collaborative browsing. The flow 100 includes accessing 110 a website within a website domain, wherein the website includes one or more products for sale, and wherein the website is viewed 112 by a plurality of users with a plurality of devices. A website domain is the name of a website, such as MyWebsite.com. The website domain name is included in a uniform resource locater (URL) which provides the specific website address for each page on a website. For example, if a website domain name is MyWebsite.com, the URL for the homepage of the website can be https://www.MyWebsite.com/homepage. The URL for ordering items for sale can be https://www.MyWebsite.com/orders, and so on. The website can be an ecommerce site for a single vendor or brand, a group of businesses, a social media platform, and so on. In embodiments, the website can be viewed on a mobile phone, laptop computer, desktop computer, tablet, pad, and so on. The accessing of the website can be accomplished using a browser or another application running on a user device. In embodiments, the accessing of the website is accomplished with an application running on a mobile device.

The flow 100 includes installing 120 a communications agent on the website, wherein the communications agent enables 122 an interaction between a user within the plurality of users and a sales associate. In embodiments, the communications agent can be installed on one or more web servers hosting one or more website domains. The communications agent can support multiple website domains simultaneously. The communications agent can generate an overlay on the website that can include a domain webpage, a text chat, or a video chat. The website overlay can be viewed on the user's browser without installing any software component on the device employed by the user. The communications agent can connect the text chat or video chat to a sales associate affiliated with the website domain. The communications agent can initiate a voice call to a user and connect the voice call to a sales associate. In embodiments, the sales associate can be human. The sales associate can be an artificial intelligence agent. In some embodiments, the interaction includes a second sales associate.

The flow 100 includes establishing 130 the interaction between the sales associate and the user, wherein the interaction includes an overlay on the website. In embodiments, information about a user can be collected as the user views pages on the website. The user information can include previous website history, chat texts, voice interactions, video usage information, clicks on website pages, time spent on website pages, searches initiated by the user, previous purchase information, and so on. The user information can be analyzed by a machine learning model. The machine learning model can predict a purchase intention by the user and alert one or more sales associates. The machine learning model can analyze user information and sales associate information to match a sales associate with the user, increasing the likelihood of a successful sales interaction. The sales associate can initiate an interaction with the user through a text chat, a voice call, or a video chat. The chat window can be included in an overlay on the website. The overlay window can be displayed on top of the webpage being viewed by the user. In embodiments, the user can select whether to interact with the sales associate. The user choice can be collected and included in the user information.

The flow 100 includes obtaining 140 a uniform resource locator (URL), by the sales associate, wherein the URL is located within the website domain. In embodiments, the URL can include a short-form video. In embodiments, the short-form video is a livestream or a livestream replay. In embodiments, the machine learning model can analyze each page of a website and determine the contents. The machine learning model can include a large language model (LLM) neural network to identify words and phrases included on each webpage and match them to products for sale on the website. In embodiments, images and videos on the webpages can be analyzed and matched to products for sale as well. A large language model is a type of machine learning model that can perform a variety of natural language (NLP) tasks, including generating and classifying text, answering questions in a human conversational manner, and translating text from one language to another. In some embodiments, a machine learning neural network can be used to recognize the gestures, facial features, lighting, and movements of each person in the livestream. In embodiments, the user information can be used by the machine learning model to select webpages that match the purchase intentions of the user. The URL of the matching webpages can be sent to the sales associate communicating with the user. In embodiments, the obtaining the URL is accomplished by the sales associate without help from the machine learning model.

The flow 100 includes directing 150 a web browser on a device of the user, to the URL, wherein the directing is accomplished without control of the device 152, wherein the user approves the directing 154, and wherein the directing is based on the communications agent. In embodiments, a URL associated with the purchase intentions of the user can be sent to the sales associate by the AI agent. The AI agent can include a machine learning model. The sales associate can interact with the user to ask permission to direct the user's browser to the URL. In some embodiments, the sales associate reviews one or more URLs sent by the AI agent and chooses one to display to the user. In embodiments, the user approves the directing 154 by voice, chat, text, or video. The directing can further comprise recognizing approval 156 of the user, by the artificial intelligence agent. The recognizing includes evaluating 158, by the artificial intelligence agent, the interaction. In embodiments, the AI agent can recognize words and phrases generated by the user to indicate approval, such as “sure”, “OK”, “why not”, “go for it”, “engage”, “make it so”, etc. The AI agent can recognize face and body gestures generated by the user to indicate approval, such as a nod, a thumbs-up, an OK gesture, a shrug, and so on. The directing can be initiated by the artificial intelligence agent based on the recognized approval of the user. The communications agent can select any URL page on a website domain and send the URL address to a user browser, based on the interaction between the user and the sales associate. The selection and sending of a website URL to a user browser can be accomplished without installing any software component or agent on the device employed by the user to browse the website.

The flow 100 further comprises enabling 160, within the short-form video, an ecommerce purchase of the one or more products for sale. In embodiments, the ecommerce purchase includes a virtual purchase cart. The enabling further comprises displaying 170, within the short-form video, the virtual purchase cart. In embodiments, the virtual purchase cart covers a portion of the short-form video. The enabling further comprises representing 180 the one or more products for sale in an on-screen product card. An ecommerce environment associated with the livestream can be generated on the viewer's mobile device or other connected television device as the rendering of the video progresses. The ecommerce environment on the viewer's mobile device can display a livestream or other video event and the ecommerce environment at the same time. A mobile device user can interact with the product card to learn more about the product with which the product card is associated. While the user is interacting with the product card, the livestream video continues to play. Purchase details of the at least one product for sale can be revealed, wherein the revealing is rendered to the viewer. The viewer can purchase the product through the ecommerce environment, including the virtual purchase cart. The viewer can purchase the product without having to “leave” the livestream event or video. Leaving the livestream event or video can include having to disconnect from the event, open an ecommerce window separate from the livestream event, and so on. The video can continue to play while the viewer is engaged with the ecommerce purchase. In embodiments, the video or livestream event can continue “behind” the ecommerce purchase window, where the virtual purchase window can obscure or partially obscure the livestream event. As discussed above and throughout, the representing further comprises showing interest 190, by the user, in the one or more products. The directing can include a second URL, wherein the second URL highlights the one or more products for sale in the on-screen product card. For example, the sales associate can direct one URL to the user in response to a specific question about a product or service. The webpage associated with the URL may include information about patterns, colors, dimensions, and so on. The directing can include an additional URL to the user that contains a livestream replay in which the product is highlighted. The second URL can include an ecommerce environment that allows the user to purchase the product. The ecommerce environment can include an on-screen product card.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

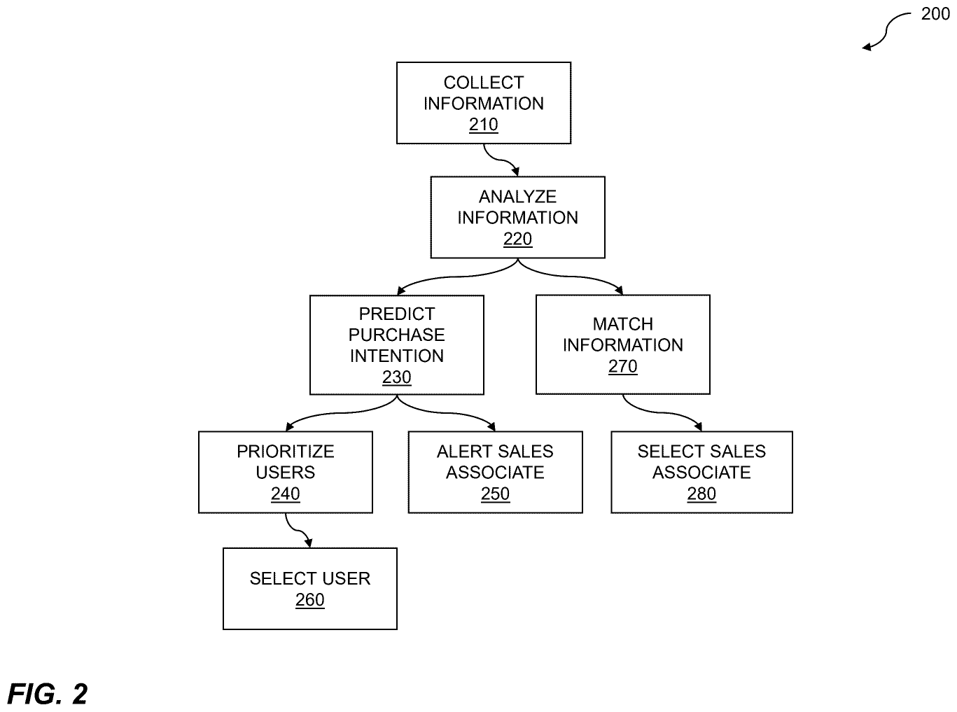

FIG. 2 is a flow diagram for enabling non-invasive collaborative browsing. The flow 200 includes collecting 210, using one or more processors, from the plurality of users, user information. In embodiments, the user information includes website history, chat text, voice interaction, or video usage information. A machine learning model including Natural Language Processing (NLP) can be used to capture and analyze spoken and written language and extract key information regarding product interests and preferences. As users log onto a website, the user ID of the user can be associated with actions taken as webpages are viewed and interactions with the pages progress. The actions can include the amount of time spent on pages, the number of products on a page investigated for more specific information, the product categories explored, short-form videos watched, products placed in virtual sales carts for purchases, and so on. Information provided by the user when purchases are made, including shipping locations, preferred payment methods, sizes, colors, patterns, and so on, can be stored. Items that are selected for purchase and later exchanged for different products, or removed and not replaced, can be recorded as well. Questions and comments made to online support staff or sales representatives, product evaluations and reviews, complaints, and so on can all be stored, associated with the user ID, and used to build a profile of the user for analysis. The user information can include one or more third party sources. Website users who access a site via a search engine can have their search profile and associated information passed on to the website. The website user ID of the user can be matched with a user ID from one or more third party sources. Internet users with social media profiles can pass on attributes and data points from their user profiles to the websites they use for ecommerce, video viewing, and so on. Associations between user IDs on various sites can be recorded and used to gain additional data from third party websites to broaden a user profile and gain insight into purchase preferences, patterns, demographic information, tastes, lifestyle choices, and so on. All of this data, or select portions of the available data, can be added to an ecommerce website or social media platform database for analysis by a machine learning model.

The flow 200 further comprises analyzing 220 the user information, wherein the analyzing is based on machine learning. Machine learning is a technology field of study devoted to understanding and building systems that “learn” based on methods that leverage data to improve computer performance of a set of tasks. Artificial intelligence algorithms are used to imitate the way in which humans learn, and through repetitive uses of datasets, gradually improve performance. In embodiments, the analyzing 220 further comprises predicting 230 a purchase intention, for the user, of the one or more products for sale, wherein the predicting is based on the analyzing, and wherein the predicting is based on machine learning. Machine learning algorithms can be used to organize user information to create profiles that can detect interests and predict likely behavior, including intentions to purchase products and services. The data collected from the website, from the user directly, from user performance on the website, and from third party sites and services in which the user participates, can be placed into one or more databases that can generate, test, and refine user profiles designed to predict user interests and intentions to purchase products and services. The purchase intention can comprise informational intent. Informational intent is the use of search queries to gather information about a particular item or topic. The purchase intention can comprise investigative intent. Investigative intent is the use of queries to establish facts to prove or disprove allegations of fraud or corruption. The purchase intention can comprise navigational intent. Navigational intent is the use of search queries to identify specific websites or webpages. The purchase intention can comprise transactional intent. Transactional intent is the use of search queries to complete a purchase or take some other type of action.

The predicting 230 further comprises alerting 250 the sales associate when the user requires help, wherein the alerting is based on the purchase intention. The machine learning model can analyze the user information, predict the purchase intention of the user, and alert the sales associate of the type of information the user is seeking. The sales associate can use the alert information to help answer user questions and find information the user is requesting. The involvement of a sales associate in the user's search for information can increase the likelihood of continued user interaction with the website and the likelihood of purchases by the user.

The predicting 230 further comprises prioritizing 240 the plurality of users, wherein the prioritizing is based on the purchase intention that was predicted. In embodiments, the level and type of purchase intention predicted by the machine learning model can be used to rank users matched to a particular sales associate. In some embodiments, the closer a user is to actually purchasing an item, the higher the priority of the user on the list of users presented to the sales associate. In other embodiments, the more a user is seeking additional information on a product, the higher the priority of the user on the list of users. In some embodiments, the sales associate can select the type of user purchase intention to prioritize. For example, one sales associate can prioritize users who are seeking additional information or trying to find a particular webpage. Other sales associates can prioritize users who are actively searching for a webpage to purchase a specific product. In some embodiments, the prioritization of users can be set by the website domain managers, operators, vendors, or system hosts. The prioritizing 240 further comprises selecting 260, by the sales associate, one user from the plurality of users that was prioritized. The list of users matched to a particular sales associate can be presented to the associate in priority order. The sales associate can review the list, collect additional information about the user, collect information about the product the user is researching, and so on. The sales associate can select a particular user and initiate communication with the user using a text chat, video chat, or voice call managed by the communication agent.

In embodiments, the analyzing 220 further comprises matching 270 the user information that was collected with one or more qualities of a plurality of sales associates. The qualities can include expertise, hobbies, appearance, conversion rate, tone, or style. The qualities can include other factors such as nationality, gender, clothing, and so on. The matching further comprises selecting 280 a specific sales associate within the plurality of sales associates, wherein the selecting is based on the matching. The machine learning model can collect information about users on a website domain and information about the sales associates connected to the domain. The user information associated with users who are seeking information related to a potential purchase or who appear ready to purchase can be matched with sales associates who are knowledgeable about the item or category of items the user is seeking. In some embodiments, the appearance of the sales associate can be matched to that of the user. The machine learning model can use demographic information about the user and the sales associate to match one to another. Similar hobbies or interests can be used, and so on. In some embodiments, an AI sales agent can be selected from a library of artificial intelligence agents to interact with the user, based on the matching criteria. The object of the matching of user to sales associate is to increase the likelihood of satisfying the user inquiries and maximizing the sales of goods and services offered by the website.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

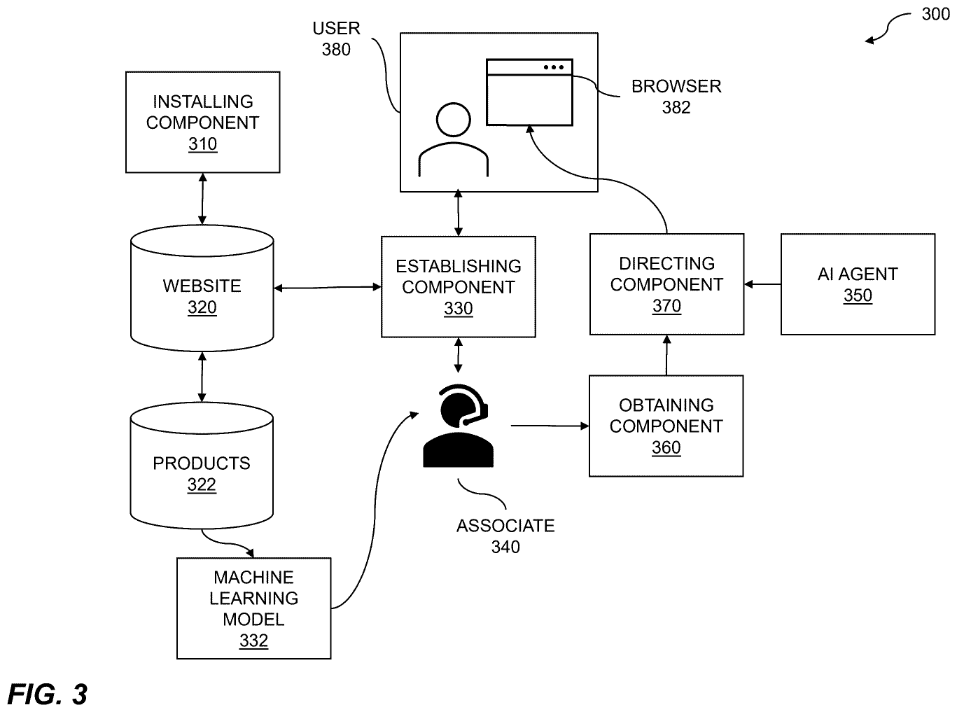

FIG. 3 is an infographic for non-invasive collaborative browsing. The infographic 300 includes accessing a website 320 within a website domain, wherein the website includes one or more products 322 for sale, and wherein the website is viewed by a plurality of users 380 with a plurality of devices. In embodiments, the website is an ecommerce site for a single vendor or brand, a group of businesses, a social media platform, and so on. The products for sale can be stored in a database that includes product names, descriptions, prices, colors, patterns, sizes, dimensions, weight, shipping details, and so on. The website can be viewed on a mobile phone, laptop computer, desktop computer, tablet, pad, and so on. The accessing of the website can be accomplished using a browser or another application running on a user device. The user device can be a mobile device. The browser 382 can be a mobile device application running on the mobile device. In some embodiments, the website comprises a database, wherein the database includes one or more products for sale, and wherein the database supports a mobile device application, wherein the mobile device application is viewed by a plurality of users with a plurality of mobile devices. The mobile device application can be a software application. The mobile devices can include a smartphone, tablet, laptop computer, and so on.

The infographic 300 includes an installing component 310. The installing component 310 can install a communications agent on the website, wherein the communications agent enables an interaction between a user within the plurality of users and a sales associate 340. In embodiments, the communications agent can be installed on one or more web servers hosting one or more website domains. The communications agent can support multiple website domains simultaneously. The communications agent can generate an overlay on the website that can include a domain webpage, a text chat, or a video chat. In embodiments, the website overlay can include a short-form video, livestream, livestream replay, and so on. The website overlay can be viewed on the user browser without installing any software component on the device employed by the user. The communications agent can connect the text chat or video chat displayed on the user device to a sales associate connected to the website domain. The communications agent can initiate a voice call to a user and connect the voice call to a sales associate. In embodiments, the communications agent connects multiple sales associates to a user. In other embodiments, the communications agent connects multiple users to a sales agent. In some embodiments, the installing component 310 provides a communications agent in the mobile device application, wherein the communications agent enables an interaction between a user 380 within the plurality of users and a sales associate 340.

The infographic 300 includes an establishing component 330. The establishing component 330 can establish the interaction between the sales associate 340 and the user 380, wherein the interaction includes an overlay on the website 320. In embodiments, information about a user can be collected as the user views pages on the website. The user information can include previous website history, chat texts, voice interactions, video usage information, clicks on website pages, time spent on website pages, searches initiated by the user, previous purchase information, and so on. The user information can be analyzed by a machine learning model 332. The machine learning model 332 can predict a purchase intention by the user and alert one or more sales associates 340. The machine learning model 332 can analyze user information and sales associate information and suggest to the associate 340 a URL to offer to redirect the user 380. In embodiments, the machine learning model 332 matches a sales associate with the user 380 in order to increase the likelihood of a successful sales interaction. The sales associate can use the establishing component 330 to initiate an interaction with the user through a text chat, a voice call, or a video chat. The chat window can be included in an overlay on the website. The overlay window can be displayed on top of the webpage being viewed in the user's browser 382. In embodiments, the user can select whether to interact with the sales associate. The user choice can be collected and included in the user information. In some embodiments, the establishing component 330 establishes the interaction between the sales associate and the user, wherein the interaction includes an overlay in the mobile device application.

The infographic 300 includes an obtaining component 360. The obtaining component 360 can obtain a uniform resource locator (URL), by the sales associate 340, wherein the URL is located within the website domain. In embodiments, the URL can include a short-form video. The short-form video can be a livestream or a livestream replay. In embodiments, a machine learning model 332 can analyze each page of a website domain and determine the contents. The machine learning model 332 can include a large language model (LLM) neural network to identify words and phrases included on each webpage and match them to products for sale on the website. In embodiments, images and videos on the webpages can be analyzed and matched to products for sale. In some embodiments, a machine learning neural network can be used to recognize the gestures, facial features, lighting, and movements of each person in the livestream. In embodiments, the user information can be analyzed by the machine learning model 332 to select webpage URLs that match the purchase intentions of the user. The URLs of webpages selected by the machine learning model can be sent to the sales associate 340 communicating with the user. In embodiments, the obtaining component can obtain information, by the sales associate, wherein the information is located within a database. In some embodiments, the obtaining component 360 obtains sales information, by the sales associate, wherein the sales information is located within the database. The sales information can include any information on the one or more products for sale including cost, usage information, ratings, how-to videos, and so on.

The infographic 300 includes a directing component 370. The directing component 370 can direct a web browser 382 on a device of the user 380 to the URL, wherein the directing is accomplished without control of the device, wherein the user 380 approves the directing, and wherein the directing is based on the communications agent. In some embodiments, the directing component directs the mobile device application, on the mobile device of the user, to display the information, wherein the directing is accomplished without control of the mobile device, wherein the user approves the directing, and wherein the directing is based on the communications agent. In embodiments, the web browser is a mobile device application on a mobile device. In embodiments, a URL associated with the purchase intentions of the user can be sent to the sales associate 340 by the machine learning model 332. The sales associate can interact with the user to ask permission in a chat or voice call to direct the user's browser to the URL. In some embodiments, the sales associate can review one or more URLs sent by the AI machine learning model and choose one to display to the user. In embodiments, the URL comes directly from the sales associate 340. In embodiments, the user approves the directing by voice, chat, text, or video. The directing component 370 can further comprise recognizing approval of the user, by the AI agent 350. The recognizing includes evaluating, by the AI agent 350, the interaction between the sales associate and the user. In embodiments, the AI agent 350 can recognize words and phrases generated by the user to indicate approval. The AI agent 350 can also recognize face and body gestures generated by the user to indicate approval. The directing can be initiated by the AI agent based on the recognized approval of the user. In some embodiments, the communications agent can select any URL page on a website domain and send the URL address to a user browser, based on the interaction between the user and the sales associate. The selection and sending of a website URL to a user browser can be accomplished without installing any software component or agent on the device employed by the user to browse the website. In some embodiments, the directing component 370 directs the mobile device application, on the mobile device of the user 380, to display the sales information, wherein the directing is accomplished without control of the mobile device, wherein the user approves the directing, and wherein the directing is based on the communications agent.

Embodiments can include accessing a database, wherein the database includes one or more products for sale, and wherein the database supports a mobile device application, wherein the mobile device application is viewed by a plurality of users with a plurality of mobile devices; providing a communications agent in the mobile device application, wherein the communications agent enables an interaction between a user within the plurality of users and a sales associate; establishing the interaction between the sales associate and the user, wherein the interaction includes an overlay in the mobile device application; obtaining sales information, by the sales associate, wherein the sales information is located within the database; and directing the mobile device application, on the mobile device of the user, to display the sales information, wherein the directing is accomplished without control of the mobile device, wherein the user approves the directing, and wherein the directing is based on the communications agent.

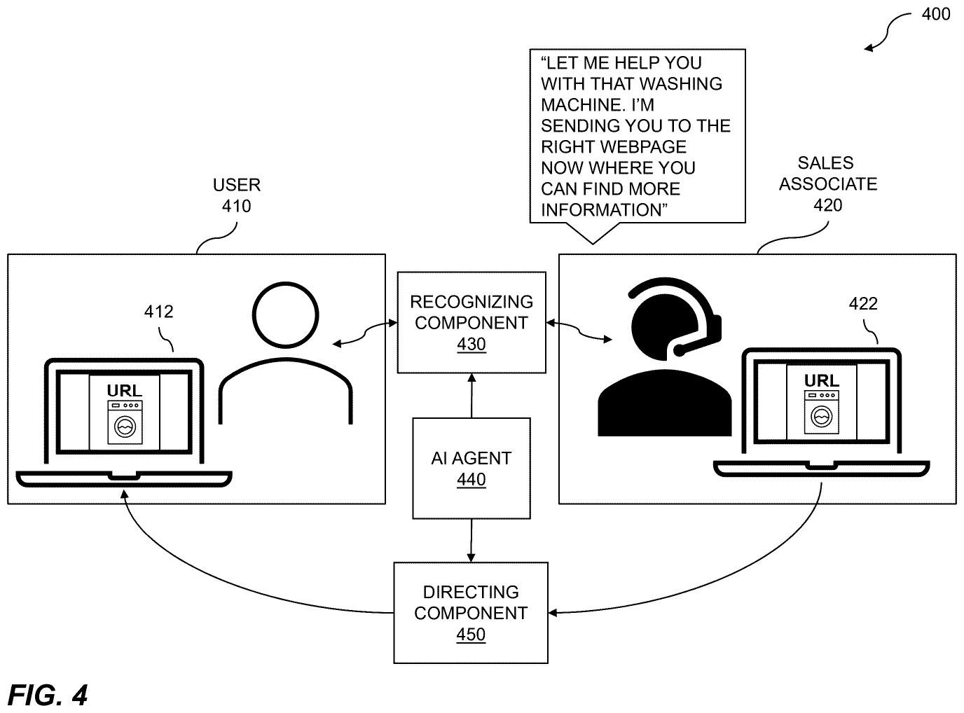

FIG. 4 is an example of collaborative browsing. The example 400 includes a user 410 viewing a website within a website domain. The website includes one or more products for sale. One or more users can view the website with a plurality of devices 412. In embodiments, the user can use a personal computer, mobile phone, pad, tablet, or another device with access to the Internet and with web browsing capabilities. The example 400 includes a sales associate 420. The sales associate can be a human. The sales associate can be an artificial intelligence agent 440. In some embodiments, the interaction includes a second sales associate. In embodiments, the one or more sales associates can access the website domain using a personal computer, laptop computer, mobile device, virtual access point, and so on. The sales associates can be part of a centralized group of associates or can work from a remote location.

In embodiments, a communications agent can be installed on the website domain being viewed by the user 410. The communications agent can establish an interaction between the user and the sales associate 420. The interaction can be by voice, chat, text, or video. As the user interacts with webpages on the domain, user information can be collected and sent to a machine learning model to be analyzed. The machine learning model can predict a purchase intention for the user. In embodiments, the purchase intention can include information intent, investigative intent, navigational intent, and transactional intent. Information intent is the lowest level of purchase intention. A user with information intent is gathering information regarding a product or service, often from multiple sources. Machine learning algorithms can be used to predict whether the user has interest in purchasing a new or used car, for example, but without a pattern that indicates a specific car type, brand, or other focus, the purchase intention prediction can remain at an informational intent level. The next level of purchase intention is investigative intention. A user at this level is focusing on specific pieces of information from the various sources they have explored and has begun to find more details. The user has moved from simply gathering information to investigating specific options for purchasing a vehicle, for example. The next level of purchasing intent is navigational intent. Navigational intent is marked by one or more user search queries that name a specific website or webpage. These specific search queries or navigations to specific websites can indicate that a user has refined their interests to chosen car vendors, dealers, ecommerce sites, and so on. The highest level of user intent is transactional intent. Transactional search queries or web commands are used to complete a purchase of a product or service. The user has now made the decision to purchase a product and has initiated the transactions necessary to complete the purchase. Data relating to user interests at varying levels can be included in the machine learning model and used to generate likely purchase intentions for users as they navigate through a website and view information about products.

The machine learning model can analyze the user information and purchase intention and select webpage URLs from the domain that match the user purchase intention. The webpage URLs can be generated by the sales associate 420. The selected webpage URLs 422 can be sent to the sales associate 420. The sales associate can interact with the user and offer additional information to the user. In the example 400, the sales associate can be notified of the user's purchase intention regarding a washing machine. The machine learning model can send a URL to the sales associate with additional information about the washing machine. The sales associate can then offer to send the URL to the user. In the example 400, the sales associate 420 says, “Let me help you with that washing machine. I'm sending you to the right webpage now where you can find more information.” Based on the user's approval, the sales associate can send the URL to the user's browser.

The example 400 includes a recognizing component 430. The recognizing component 430 can recognize approval of the user 410, by an artificial intelligence agent 440. The recognizing component 430 includes evaluating, by an artificial intelligence (AI) agent 440, the interaction between the sales associate 420 and the user 410. In embodiments, the AI agent recognizes words and phrases generated by the user to indicate approval, such as “sure”, “OK”, “why not”, “go for it”, “engage”, “make it so”, etc. The AI agent can recognize face and body gestures generated by the user to indicate approval, such as a nod, a thumbs-up, an OK gesture, a shrug, and so on. The directing can be initiated by the AI agent based on the recognized approval of the user. In embodiments, the communications agent can select any URL page on a website domain and send the URL address to a user browser, based on the interaction between the user and the AI agent, and/or the interaction between the user and a human sales associate. The selection and sending of a website URL to a user browser can be accomplished without installing any software component or agent on the device employed by the user to browse the website.

The example 400 includes a directing component 450. The directing component 450 can direct a web browser on a device of the user to the URL 422, wherein the directing is accomplished without control of the device, wherein the user approves the directing, and wherein the directing is based on the communications agent. In embodiments, a URL associated with the purchase intentions of the user can be sent to the sales associate by the machine learning model. The sales associate can interact with the user to ask permission to direct the user's browser to the URL. In some embodiments, the sales associate can review one or more URLs sent by the machine learning model and choose one to display to the user. In embodiments, the user approves the directing by voice, chat, text, or video. The recognizing component 430 can recognize the approval of the user and send the URL to the user. In embodiments, the sales associate can recognize the approval of the user and send the URL to the user.

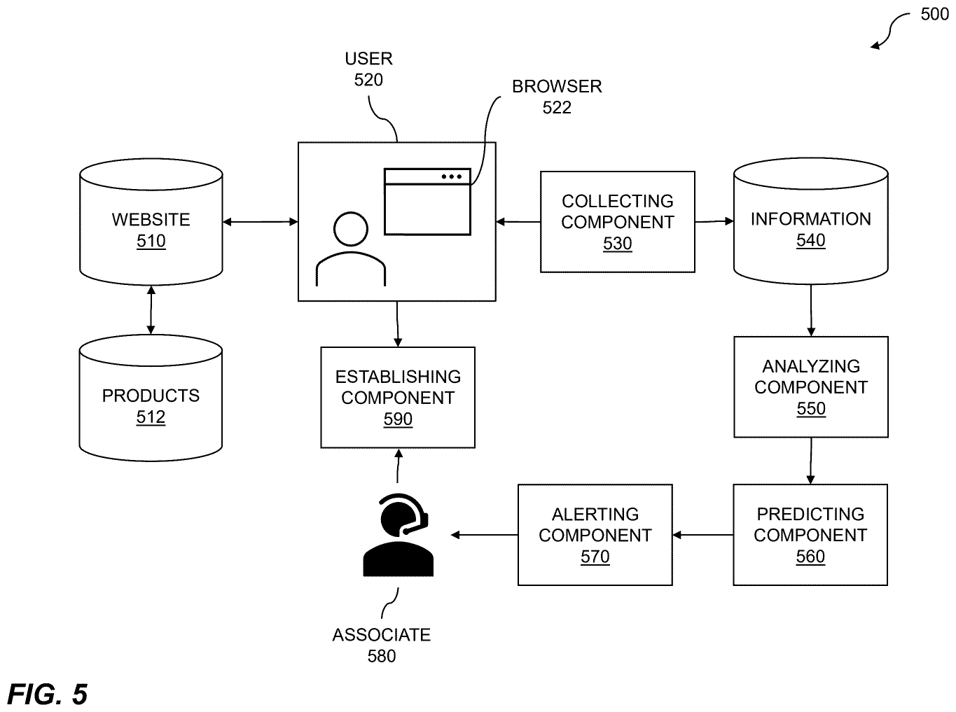

FIG. 5 is an infographic for alerting a sales associate. The infographic 500 includes accessing a website 510 within a website domain, wherein the website includes one or more products for sale 512, and wherein the website is viewed by a plurality of users 520 with a browser 522. As mentioned above and throughout, the user can use a personal computer, mobile phone, pad, tablet, or another device with access to the Internet and with web browsing capabilities. The infographic 500 includes a sales associate 580. The sales associate can be a human. The sales associate can be an artificial intelligence agent. In embodiments, the sales associate can access the website domain using a personal computer, laptop computer, mobile device, virtual access point, and so on. The sales associate can be part of a centralized group of associates or can work from a remote location.

The infographic 500 includes a collecting component 530. The collecting component 530 can collect, using one or more processors, from the plurality of users, user information 540. The user information 540 includes website history, chat text, voice interaction, or video usage information. As users log onto a website, the user ID of the user can be associated with actions taken as webpages are viewed and interactions with the pages progress. The actions can include the amount of time spent on pages, the number of products on a page investigated for more specific information, the product categories explored, short-form videos watched, products placed in virtual sales carts for purchases, and so on. Information provided by the user when purchases are made, including shipping locations, preferred payment methods, sizes, colors, patterns, and so on, can be stored. Items that are selected for purchase and later exchanged for different products, or removed and not replaced, can be recorded as well. Associations between user IDs on various sites can be recorded and used to gain additional data from third party websites to broaden a user profile and gain insight into purchase preferences, patterns, demographic information, tastes, lifestyle choices, and so on. All of this data, or select portions of the available data, can be added to an ecommerce website or social media platform database for analysis by a machine learning model.

The infographic 500 includes an analyzing component 550. The analyzing component 550 can analyze the user information, wherein the analyzing is based on machine learning. As mentioned above and throughout, the analyzing can be used to match the user information 540 that was collected with one or more qualities of a plurality of sales associates 580. The sales associate qualities can include expertise, hobbies, appearance, conversion rate, tone, or style. The machine learning model can further be used to select a specific sales associate 580 within the plurality of sales associates, wherein the selecting is based on the matching.

The machine learning analysis can include a predicting component 560. The predicting component 560 can be used to predict a purchase intention, for the user, of the one or more products for sale, wherein the predicting is based on the analyzing, and wherein the predicting is based on machine learning. The purchase intention can comprise informational intent, which is the use of search queries to gather information about a particular item or topic. The purchase intention can comprise investigative intent, which is the use of queries to establish facts to prove or disprove allegations of fraud or corruption. The purchase intention can comprise navigational intent, which is the use of search queries to identify specific websites or webpages. The purchase intention can comprise transactional intent, which is the use of search queries to complete a purchase or take some other type of action.

The infographic 500 includes an alerting component 570. The alerting component 570 can alert the sales associate matched to the user when the user requires help, wherein the alerting is based on the purchase intention. In embodiments, the alerting 570 can be accomplished by voice, chat, text, or video. The alert can appear in a list of users that are matched to a particular sales associate. The alert can include webpage URLs that include the information the user is seeking. In some embodiments, the alert can include an overlay that includes a text, chat box, video, or voice communication interface ready to connect to the associated user.

The infographic 500 includes an establishing component 590. The establishing component 590 can be used to establish the interaction sales associate and the user, wherein the interaction includes an overlay on the website. As mentioned above, information about a user can be collected as the user views pages on the website. The machine learning model can analyze user information and sales associate information to match a sales associate with the user in order to increase the likelihood of a successful sales interaction. In embodiments, the establishing is initiated by the sales associate. The sales associate can initiate an interaction with the user through a text chat, a voice call, or a video chat. The chat window can be included in an overlay on the website. The overlay window can be displayed on top of the webpage being viewed by the user. In embodiments, the user can select whether to interact with the sales associate. The user choice can be collected and included in the user information. The interaction between the sales associate and the user can include sending URLs to the user browser 522 to display more information to the user related to products for which the user shows an intention to purchase. The interaction can increase the likelihood of sales of products and services.

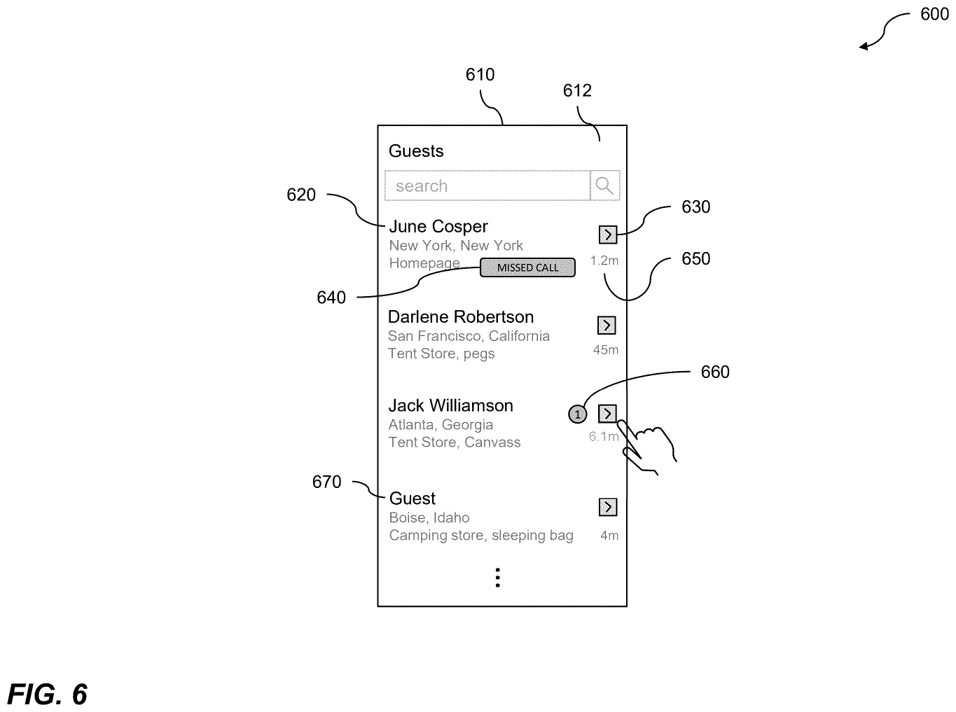

FIG. 6 is an example of prioritizing users. The example 600 includes a device 610 that can access a website 612 within a website domain, wherein the website includes one or more products for sale. The website can be viewed by a plurality of users with a plurality of devices. The website domain back-office operations areas can be viewed by a plurality of sales associates using a plurality of devices. The devices can include a mobile phone, laptop computer, desktop computer, tablet, pad, and so on. The accessing of the website can be accomplished using a browser or another application running on a user device.

The example 600 includes a list of users who require help from a sales associate. In embodiments, the users can be monitored as they browse webpages on the website domain. User information can be gathered based on the user ID information and activity on the website. The data collected from the website, from the user directly, from user performance on the website, and from third party sites and services in which the user participates can be placed into one or more databases that can be used by machine learning models to generate, test, and refine user profiles designed to predict user interests and intentions to purchase products and services. The purchase intention can include informational intent, investigative intent, navigational intent, and transactional intent. As users interact with the website domain pages and the machine learning model collects user information, predictions of the users purchase intentions are generated and prioritized. In some embodiments, the prioritization criteria can be set by the sales associate or the website domain operations staff.

In embodiments, sales associate qualities are collected and analyzed by the machine learning model. The qualities can include expertise, hobbies, appearance, conversion rate, tone, style, and so on. The machine learning model can analyze the user information, purchase intention predictions, and sales associate qualities to match prioritized users with purchase intentions and sales associates who are best qualified to interact with the users and address the users' queries. The interactions between the users and sales associates can help to raise the level of customer satisfaction and increase the likelihood of product sales. In embodiments, the users can ask for help directly by selecting a help chat or support page on the website. The sales associate can also initiate an interaction with the user based on the list of users presented to them by the machine learning model.

In some embodiments, the sales associate can be an AI sales agent. Information about the user, including demographic, economic, and geographic data collected by the host website, can be combined with the image of the user captured from a video chat and used as input to an AI machine learning model. The AI neural network can analyze the user information to select an image of a synthetic host that can be customized to interact with the user during a chat or voice call session. In some embodiments, a human host can view and hear the user question or comment received in the chat or voice call and can respond to it. The human host response can be captured and used as input to an AI machine learning model. The AI model can be used to combine the selected image of the synthetic host with the performance of the human host to create a synthetic host performance so that the image and voice of the synthetic host replaces the human host. The synthetic host performance can be customized so that the background includes information about products for sale, product use, additional education options, etc. The synthetic host performance can be rendered to the video chat so that the user sees and hears the synthetic host responding to the comment or question submitted by the user. If a text chat is being used, the user can see an image of the synthetic host along with the text responses from the human host.

The example 600 includes a prioritized list of users with purchase intentions that has been matched to a sales associate. The list of users can include the name of the user 620. In embodiments, the name can be acquired directly from the user in a chat or voice call session, or from user information stored on the website or an external website source, including a search engine profile, a social media profile, financial information stored to provide payment details, and so on. In cases where a name is not available, a generic name such as “Guest” 670 can be used. In some embodiments, the name 620 can be accompanied by location details, the current webpage displayed on the user's browser, and so on. The list of users can include status information 640 related to user interactions with the sales associates. In the example 600, a missed call indicator is shown. The status indictors can include call in progress, on hold, missing email address, and so on. The list of users can include the amount of time 650 the user has been displayed on the list. In some embodiments, the time elapsed 650 can be used to recalculate the prioritization of users on the list at designated intervals, or when users are added or removed from the list. The list of users can include a priority indicator 660. The priority indicator can be used to recommend to the sales associate which user to address first or next, based on the prioritization of purchase intentions generated by the machine learning model. In example 600, the name “Jack Williamson” has been designated as the number 1 priority 660. The sales associate mouse pointer can be seen selecting the start interaction button 630 related to Jack Williamson. The start interaction button 630 can be used to initiate an interaction between the sales associate and the user, based on the communications agent installed on the website domain. The interaction can be displayed as a text message, a text, voice, or video chat, or can be initiated as a voice call to the user. The interaction with the user can be accomplished without taking control of the user device in any way.

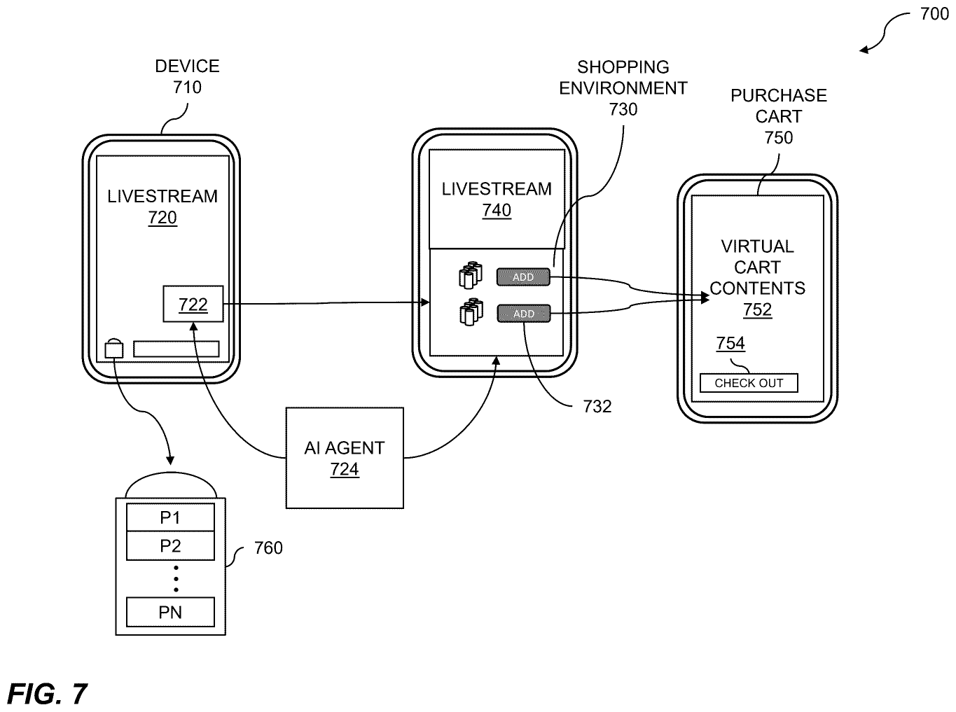

FIG. 7 is an example of an ecommerce purchase environment. The example 700 includes enabling, within a short-form video, an ecommerce purchase of the one or more products for sale. The short-form video can be a livestream 720 or livestream replay. As mentioned earlier and throughout, the sales associate can send one or more URLs to the user to provide more information about a product for sale. The URL can contain a short-form video which can include a livestream 720 or livestream replay. The livestream 720 can highlight one or more products for sale on the website for which the user has expressed purchase intentions.

The example 700 includes a device 710 displaying a short-form video as part of a livestream event. In embodiments, the livestream video can be viewed in real time or replayed at a later time. The device 710 can be a smart TV which can be directly attached to the Internet; a television connected to the Internet via a cable box, TV stick, or game console; an Over-the-Top (OTT) device such as a mobile phone, laptop computer, tablet, pad, or desktop computer; etc. In embodiments, the accessing the livestream video on the device can be accomplished using a browser or another application running on the device.

The example 700 includes generating and revealing a product card 722 on the device 710. In embodiments, the product card represents at least one product available for purchase while the livestream or short-form video plays. Embodiments can include inserting a representation of the first object into the on-screen product card. A product card is a graphical element such as an icon, thumbnail picture, thumbnail video, symbol, or other suitable element that is displayed in front of the video. The product card is selectable via a user interface action such as a press, swipe, gesture, mouse click, verbal utterance, or other suitable user action. The product card can be inserted when the livestream 720 or livestream video segment 740 are visible in the livestream event. When the product card is invoked, an in-frame shopping environment 730 is rendered over a portion of the video while the video continues to play. This rendering enables an ecommerce purchase 732 by a user while preserving a continuous video playback session. In other words, the user is not redirected to another site or portal that causes the video playback to stop. Thus, viewers are able to initiate and complete a purchase completely inside of the video playback user interface, without being directed away from the currently playing video. Allowing the video or livestream event to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

The example 700 includes rendering an in-frame shopping environment 730 to enable a purchase of the at least one product for sale by the viewer, wherein the ecommerce purchase is accomplished within the video or livestream event window 740. In embodiments, the video or livestream event can include a short-form video included in a URL forwarded by a sales associate or an inserted livestream video segment. In some embodiments, the inserted livestream video segment can be selected by the user from the webpage designated by the URL forwarded by the sales associate. The enabling can include revealing a virtual purchase cart 750 that supports checkout 754 of virtual cart contents 752, including specifying various payment methods, and application of coupons and/or promotional codes. In some embodiments, the payment methods can include fiat currencies such as United States dollar (USD), as well as virtual currencies, including cryptocurrencies such as Bitcoin. In some embodiments, more than one object (product) can be highlighted and enabled for ecommerce purchase. In embodiments, when multiple items are purchased via product cards during the livestream event, the purchases 760 are cached until termination of the video, at which point the orders are processed as a batch. The termination of the video can include the user stopping playback, the user exiting the video window, the livestream ending, or a prerecorded video ending. The batch order process can enable a more efficient use of computer resources, such as network bandwidth, by processing the orders together as a batch instead of processing each order individually.

The example 700 includes an AI agent 724. The AI agent 724 can monitor the interactions between the user, the livestream, and the shopping environment. In embodiments, the user can approve purchases by voice, chat, text, or video during the livestream or livestream playback viewed by the user. As discussed above and throughout, the webpage can be accessed by a URL sent to the user by a sales associate. The AI agent 724 can recognize responses of the user regarding purchasing choices which can be made during a livestream event or livestream playback. The AI agent recognizing includes evaluating the interaction between the sales associate and the user, and between the user and the livestream event. In embodiments, the AI machine learning model can recognize words and phrases generated by the user to indicate purchasing approvals, such as “Sure”, “OK”, “Buy it”, “Get it now”, “I want it”, etc. The machine learning model can recognize face and body gestures generated by the user to indicate approval, such as a nod, a thumbs-up, an OK gesture, a shrug, and so on. Purchases can be initiated by the artificial intelligence agent 724 based on the recognized approval of the user. In some embodiments, the user can require a PIN or other secondary authorization prior to completing a purchase. The product purchases initiated through a user's browser during a livestream can be accomplished without installing any software component or agent on the device employed by the user to browse the website livestream event. In some embodiments, a human sales associate can interact with the user and participate in purchasing choices made by the user during livestream events. The addition of an AI agent can allow users to interact with livestreams or livestream playback events at times of their choosing, and still interact with a sales associate which can provide additional information, display alternate purchase options, and so on. The ability for the user to purchase products and access information about products at any time can increase the overall effectiveness of the website and increase sales.

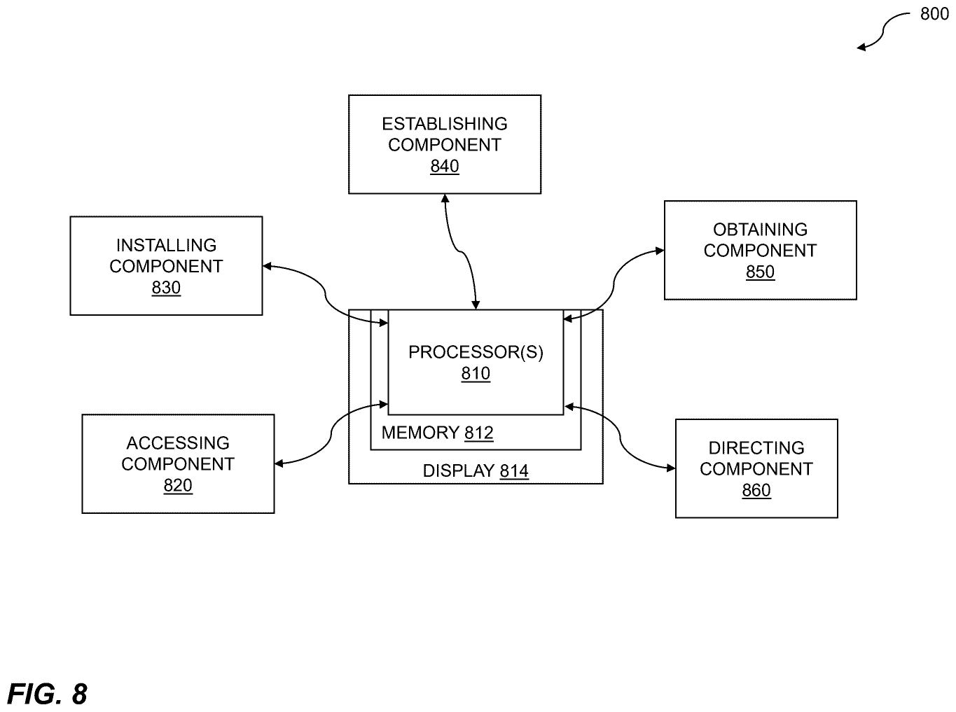

FIG. 8 is a system diagram for non-invasive collaborative browsing. The system 800 includes one or more processors 810 coupled to a memory 812 which stores instructions. The system 800 includes a display 814 coupled to the one or more processors 810 for displaying data, database information, programming details, intermediate steps, instructions, and so on. In embodiments, one or more processors 810 are attached to the memory 812 where the one or more processors, when executing the instructions which are stored, are configured to: access a website within a website domain, wherein the website includes one or more products for sale, and wherein the website is viewed by a plurality of users with a plurality of devices; install a communications agent on the website, wherein the communications agent enables an interaction between a user within the plurality of users and a sales associate; establish the interaction between the sales associate and the user, wherein the interaction includes an overlay on the website; obtain a uniform resource locator (URL), by the sales associate, wherein the URL is located within the website domain; and direct a web browser on a device of the user, to the URL, wherein the directing is accomplished without control of the device, wherein the user approves the directing, and wherein the directing is based on the communications agent.

The system 800 includes an accessing component 820. The accessing component 820 includes functions and instructions for accessing a website within a website domain, wherein the website includes one or more products for sale, and wherein the website is viewed by a plurality of users with a plurality of devices. In embodiments, the website can be an ecommerce site for a single vendor or brand, a group of businesses, a social media platform, and so on. The website can be viewed on a mobile phone, laptop computer, desktop computer, tablet, pad, and so on. The accessing of the website can be accomplished using a browser or another application running on a user device.

The system 800 includes an installing component 830. The installing component 830 includes functions and instructions for installing a communications agent on the website, wherein the communications agent enables an interaction between a user within the plurality of users and a sales associate. In embodiments, the communications agent can be installed on one or more web servers hosting one or more website domains. The communications agent can support multiple website domains simultaneously. The communications agent can generate an overlay on the website that can include a domain webpage, a text chat, or a video chat. The website overlay can be viewed on the user browser without control of the user device. The communications agent can connect a text chat or video chat to a sales associate connected to the website domain. The communications agent can initiate a voice call to a user and connect the voice call to a sales associate. In embodiments, the sales associate can be human. The sales associate can be an artificial intelligence agent.

The system 800 includes an establishing component 840. The establishing component 840 includes functions and instructions for establishing the interaction between the sales associate and the user, wherein the interaction includes an overlay on the website. In embodiments, the interaction comprises a text chat or voice call. The interaction can comprise a video chat. In some embodiments, the interaction can include a second sales associate. A machine learning model can analyze user information and sales associate information to match a sales associate with the user, based on the purchase intention of the user. The chat window can be included in an overlay on the website which can be displayed on top of the webpage being viewed by the user. In some embodiments, the user can select whether to interact with the sales associate. The user choice can be collected and included in the user information.

The system 800 includes an obtaining component 850. The obtaining component 850 includes functions and instructions for obtaining a uniform resource locator (URL), by the sales associate, wherein the URL is located within the website domain. In embodiments, the URL includes a short-form video. The short-form video is a livestream or livestream replay. The URL can include enabling, within the short-form video, an ecommerce purchase of the one or more products for sale. In embodiments, the machine learning model can analyze each page of a website and determine the contents. User information can be used by the machine learning model to select webpages that match the purchase intentions of the user. The URL of the matching webpages can be sent to the sales associate communicating with the user.

The system 800 includes a directing component 860. The directing component 860 includes functions and instructions for directing a web browser on a device of the user, to the URL, wherein the directing is accomplished without control of the device, wherein the user approves the directing, and wherein the directing is based on the communications agent. The user approves the directing by voice, chat, text, or video. A human sales associate can direct the user browser to the URL based on the approval of the user. In some embodiments, the directing component further comprises recognizing approval, of the user, by the AI agent. The directing can be initiated by the artificial intelligence agent. The recognizing includes evaluating, by the artificial intelligence agent, the interaction. The AI agent can interact with the user, evaluate the interaction, and recognize the responses of the user during the interaction. The AI agent can recognize words and phrases generated by the user to indicate approval or disapproval. The machine learning model can recognize face and body gestures generated by the user to indicate approval or disapproval. The communications agent can select any URL page on a website domain and send the URL address to a user browser, based on the interaction between the user and the sales associate. The selection and sending of a website URL to the user browser can be accomplished without controlling the user device.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for video sharing comprising:
accessing a website within a website domain, wherein the website includes one or more products for sale, and wherein the website is viewed by a plurality of users with a plurality of devices;
installing a communications agent on the website, wherein the communications agent enables an interaction between a user within the plurality of users and a sales associate;
establishing the interaction between the sales associate and the user, wherein the interaction includes an overlay on the website;
obtaining a uniform resource locator (URL), by the sales associate, wherein the URL is located within the website domain; and
directing a web browser on a device of the user, to the URL, wherein the directing is accomplished without control of the device, wherein the user approves the directing, and wherein the directing is based on the communications agent.

2. The method of claim 1 wherein the user approves the directing by voice, chat, text, or video.

3. The method of claim 2 further comprising recognizing approval, of the user, by an artificial intelligence agent.

4. The method of claim 3 wherein the directing is initiated by the artificial intelligence agent.

5. The method of claim 4 wherein the recognizing includes evaluating, by the artificial intelligence agent, the interaction.

6. The method of claim 1 further comprising collecting, using one or more processors, from the plurality of users, user information.

7. The method of claim 6 wherein the user information includes website history, chat text, voice interaction, or video usage information.

8. The method of claim 6 further comprising analyzing the user information, wherein the analyzing is based on machine learning.

9. The method of claim 8 further comprising matching the user information that was collected with one or more qualities of a plurality of sales associates.

10. The method of claim 9 wherein the qualities include expertise, hobbies, appearance, conversion rate, tone, or style.

11. The method of claim 10 further comprising selecting a specific sales associate within the plurality of sales associates, wherein the selecting is based on the matching.

12. The method of claim 8 further comprising predicting a purchase intention, for the user, of the one or more products for sale, wherein the predicting is based on the analyzing, and wherein the predicting is based on machine learning.

13. The method of claim 12 further comprising alerting the sales associate when the user requires help, wherein the alerting is based on the purchase intention.

14. The method of claim 13 wherein the purchase intention comprises informational intent.

15. The method of claim 13 wherein the purchase intention comprises investigative intent.

16. The method of claim 13 wherein the purchase intention comprises navigational intent.

17. The method of claim 13 wherein the purchase intention comprises transactional intent.

18. The method of claim 13 wherein the establishing is initiated by the sales associate.

19. The method of claim 12 further comprising prioritizing the plurality of users, wherein the prioritizing is based on the purchase intention that was predicted.

20. The method of claim 19 further comprising selecting, by the sales associate, one user from the plurality of users that was prioritized.

21. The method of claim 1 wherein the interaction includes a second sales associate.

22. The method of claim 1 wherein the directing includes an additional URL.

23. A computer-implemented method for video sharing comprising:
accessing a database, wherein the database includes one or more products for sale, and wherein the database supports a mobile device application, wherein the mobile device application is viewed by a plurality of users with a plurality of mobile devices;
providing a communications agent in the mobile device application, wherein the communications agent enables an interaction between a user within the plurality of users and a sales associate;
establishing the interaction between the sales associate and the user, wherein the interaction includes an overlay in the application;
obtaining sales information, by the sales associate, wherein the sales information is located within the database; and
directing the mobile device application, on the mobile device of the user, to display the sales information, wherein the directing is accomplished without control of the mobile device, wherein the user approves the directing, and wherein the directing is based on the communications agent.

24. A computer program product embodied in a non-transitory computer readable medium for video sharing, the computer program product comprising code which causes one or more processors to perform operations of:
accessing a website within a website domain, wherein the website includes one or more products for sale, and wherein the website is viewed by a plurality of users with a plurality of devices;
installing a communications agent on the website, wherein the communications agent enables an interaction between a user within the plurality of users and a sales associate;
establishing the interaction between the sales associate and the user, wherein the interaction includes an overlay on the website;
obtaining a uniform resource locator (URL), by the sales associate, wherein the URL is located within the website domain; and
directing a web browser on a device of the user, to the URL, wherein the directing is accomplished without control of the device, wherein the user approves the directing, and wherein the directing is based on the communications agent.
